(19) United States
(12) Patent Application Publication
(10) Pub. No.: US 2025/0376402 A1
(43) Pub. Date: Dec. 11, 2025

(54) Long Term Immobilization of Cesium

(71) Applicant: University of Manitoba, Winnipeg (CA)

(72) Inventors: Scott Kroeker, Winnipeg (CA); Arun Krishnamurthy, Winnipeg (CA)

(21) Appl. No.: 19/210,336

(22) Filed: May 16, 2025

Related U.S. Application Data
(60) Provisional application No. 63/648,976, filed on May 17, 2024.

(51) Int. Cl. C03B 5/00; C01D 17/00

(52) U.S. Cl. CPC C03B 5/005; C01D 17/003

(57) ABSTRACT

Described herein is a method for combining waste-loaded zeolites and geopolymers with glass-forming components to produce materials with improved chemical durability and stability.

The instant application claims the benefit of U.S. Provisional Patent Application 63/648,976, filed May 17, 2024 and entitled Long Term Immobilization of Cesium, the entire contents of which are incorporated herein by reference for all purposes.

### BACKGROUND OF THE INVENTION

Zeolites are hydrated aluminosilicates having a tetrahedral framework made from alumina and silica.

The substitution of aluminum for silicon in their structure creates a charge imbalance and requires charge-compensating cations.

Naturally occurring zeolites, in particular clinoptilolite (CPT, [(CaK₂Na₂Mg)₄Al₈Si₄O₉₆•24H₂O]), have shown significant promise in wastewater decontamination through selective sequestration of cesium.

However, the material's widespread use at nuclear energy and mining sites is hindered due to its low ion-retention capabilities in aqueous environments.

Geopolymers (GP) are alkali-activated aluminosilicate materials composed of three-dimensional frameworks consisting of [AlO₄]⁻ and [SiO₄].

Metakaolin-based geopolymer is partially amorphous dehydroxylated kaolinite formed by mixing the aluminosilicate material with alkali or alkali-silicate solution.

Geopolymers have been proposed as an encapsulation matrix for Cs loaded clinoptilolite (GP-Cs), as they exhibit compatible mechanical and chemical characteristics.

However, previous attempts at encapsulating CPT in GPs have produced inhomogeneous composite materials which suffer from insufficient durability and high Cs leach rates, deeming them unsuitable for sequestration and retention of Cs radioisotopes over timescales commensurate with radioactive decay half-lives.

### SUMMARY OF THE INVENTION

According to an aspect of the invention, there is provided a method for preparing a waste-loaded vitrified zeolite composition comprising:
providing waste-loaded variants comprising waste-loaded CPT in dehydrated or non-dehydrated forms, either as CPT alone (CPT-Cs) or waste-loaded CPT as a geopolymer (CPT-Cs-GP), and at different stages of maturation;
adding suitable glass-forming chemicals to the waste-loaded variants, thereby forming a mixture;
grinding the mixture;
forming a melt from the mixture by heating; and
allowing the melt to cool, thereby forming a waste-loaded zeolite glass composition (CPT-Cs-GG and CPT-Cs-GP-GG).

### BRIEF DESCRIPTION OF THE DRAWINGS

FIG. 1 is a flow chart showing the experiment approach taken for the Geoglass production.

FIG. 2 is a table showing the compositions of the different wasteforms after Cs uptake.

FIG. 3 shows ²³Na MAS NMR and ¹³³Cs MAS NMR of CPT and Cs-loaded CPT.

FIG. 4 shows X-ray diffraction of non-vitrified Cs-loaded wasteforms and the corresponding Geoglasses of the invention.

FIG. 5 is a table showing the compositions of the different Geoglasses of the invention.

FIG. 6 compares the ¹³³Cs MAS NMR of the non-vitrified wasteforms and corresponding Geoglasses.

FIG. 7 compares the ²³Na MAS NMR of the non-vitrified wasteforms and corresponding Geoglasses.

FIG. 8 compares the ²⁷AI MAS NMR of the non-vitrified wasteforms and corresponding Geoglasses.

FIG. 9 shows the ¹¹B MAS NMR and ²⁹Si MAS NMR spectra of the different Geoglasses

FIG. 10 shows concentration of cesium released into solution over time for the wasteforms and the corresponding Geoglasses.

FIG. 11 shows X-ray diffraction indicating the crystalline and amorphous nature of the non-vitrified wasteforms and the geoglasses, respectively, after dissolution.

FIG. 12 shows a scheme to consolidate nuclear waste by using waste-loaded Geoglasses as a starting material for vitrifying intermediate- and high-level wastes.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

Described herein is a method for combining waste-loaded zeolites, waste-loaded geopolymers, or waste-loaded zeolites encapsulated in geopolymers with glass-forming components to produce materials with improved chemical durability and stability.

In one embodiment of the invention, there is provided a method for preparing a waste-loaded zeolite glass composition comprising:
waste-loaded CPT in dehydrated and non-dehydrated forms, either as CPT alone or waste-loaded CPT as a geopolymer in dehydrated and non-dehydrated form and at different stages of maturation.
adding suitable glass-forming chemicals to the dehydrated waste-loaded zeolite, thereby forming a mixture;
grinding the mixture;
forming a melt from the mixture by heating; and
allowing the melt to cool, thereby forming a waste-loaded zeolite glass composition.

According to another aspect of the invention, there is provided a method for preparing a waste-loaded vitrified zeolite composition comprising:
providing waste-loaded variants comprising waste-loaded CPT in dehydrated or non-dehydrated forms, either as CPT alone (CPT-Cs) or waste-loaded CPT as a geopolymer (CPT-Cs-GP), and at different stages of maturation;
adding suitable glass-forming chemicals to the waste-loaded variants, thereby forming a mixture;
grinding the mixture;
forming a melt from the mixture by heating; and
allowing the melt to cool, thereby forming a waste-loaded zeolite glass composition (CPT-Cs-GG and CPT-Cs-GP-GG).

As will be understood by those of skill in the art, the exact “recipe” followed will depend on many factors, such as, for example, the composition of the “wasteform” (i.e., what are the chemical constituents in the specific zeolitic and/or geopolymer wasteform).

In some embodiments, the “waste” is cesium, strontium or uranium.

In some embodiments, the “waste” is cesium- and strontium-bearing sodium-rich nuclear waste in a sludge and dried oxide form.

In some embodiments, the waste-loaded zeolite is cesium-loaded zeolite, for example, CPT.

As will be understood by those of skill in the art, there is a very wide range of zeolites known to adsorb Cs (e.g., mordenite, bentonite, chabazite and others) as well as many metal-organic frameworks (MOFs). As will be understood, for a suitable material, selectivity is one issue (i.e., does it adsorb OTHER cations as well?) and overall uptake is another, with the latter being affected by the former.

In some embodiments, the waste-loaded zeolite is dehydrated at about 50 to about 400° C., or about 100 to about 400° C., for example, about 150° C. As used herein, “about” refers to the base value plus or minus 10% or in this case, 135-165° C.

In some embodiments, the suitable glass-forming chemicals are added in appropriate amounts to achieve the target final glass composition. For example, any suitable alkali-earth oxide and/or alkaline earth oxides may be used for glass formation within the application.

In some embodiments, the suitable glass-forming chemicals are added in appropriate amounts to the hydrated waste-loaded zeolite and variants to achieve the target final glass composition.

In some embodiments of the invention, the suitable glass-forming chemicals include or comprise about 15 parts (Na₂O), about 5 parts (Al₂O₃), about 25 parts (B₂O₃) and about 55 (SiO₂) or 15 (Na₂O)-5 (Al₂O₃)-25 (B₂O₃)-55 (SiO₂).

In some embodiments of the invention, the suitable glass-forming chemicals include or comprise about 5-30 parts (Na₂O), about 5-30 parts (Al₂O₃), about 15-40 parts (B₂O₃) and about 40-60 (SiO₂) or 5-30 (Na₂O)-5-30 (Al₂O₃)-15-40 (B₂O₃)-40-10 60 (SiO₂).

In some embodiments of the invention, the suitable glass-forming chemicals include or comprise about 5-30 parts (Na₂O), about 5-30 parts (Al₂O₃), about 15-40 parts (B₂O₃), about 1-10 parts of (P₂O₅) and about 40-60 (SiO₂) or 5-30 (Na₂O)-5-30 (Al₂O₃)-15-40 (B₂O₃)-40-60 (SiO₂)-1-10 (P₂O₅). In some embodiments of the invention, the suitable glass-forming chemicals are added in oxide form and/or a combination of these oxides in a pre-made sintered form with above-listed target composition.

In some embodiments, typical amounts to make about 2 g of Geoglass are: about 1.2 g CPT-Cs (dry), about 0.5 g B₂O₃, about 0.2 g Na₂CO₃, and about 0.1 g SiO₂. In other embodiments, typical amounts to make 2 g of geoglass are: 0.8-1.2 g CPT-Cs (dry), 0.2-0.7 g B₂O₃, 0.1-0.4 g Na₂CO₃, and 0.1-0.3 g SiO₂.

As will be apparent to those of skill in the art, without adding these oxides-especially boron—the material will not melt at the specified temperature, thereby requiring prohibitively high melting temperatures, and will not become purely glass. As such, in these embodiments, boron is essential.

As will be apparent to those of skill in the art, different solutions and different temperatures may be used and are within the scope of the invention.

In some embodiments, the zeolite may be pre-treated with other cations to improve cesium exchange. Considering testing different solutions and different temperatures.

In some embodiments, the solid mixture is ground in a mortar-and-pestle.

In some embodiments, the solid mixture is prepared by wet-grinding, and ball milling.

In some embodiments, the solid mixture is held for about 1 hour in a furnace at about 1100° C. to form the melt.

In some embodiments, the solid mixture is held for about 0.5-1.5 hours in a furnace at about 900-1200° C. to form the melt.

In some embodiments, the final glassy product is obtained by removing the melt from the furnace and allowing it to cool.

In some embodiments, the final glassy product is quenched in air or water.

In some embodiments, waste-loaded glassy products are used as a starting material to further vitrify high-level and intermediate-level nuclear waste in a sludge or oxide—a waste consolidation approach.

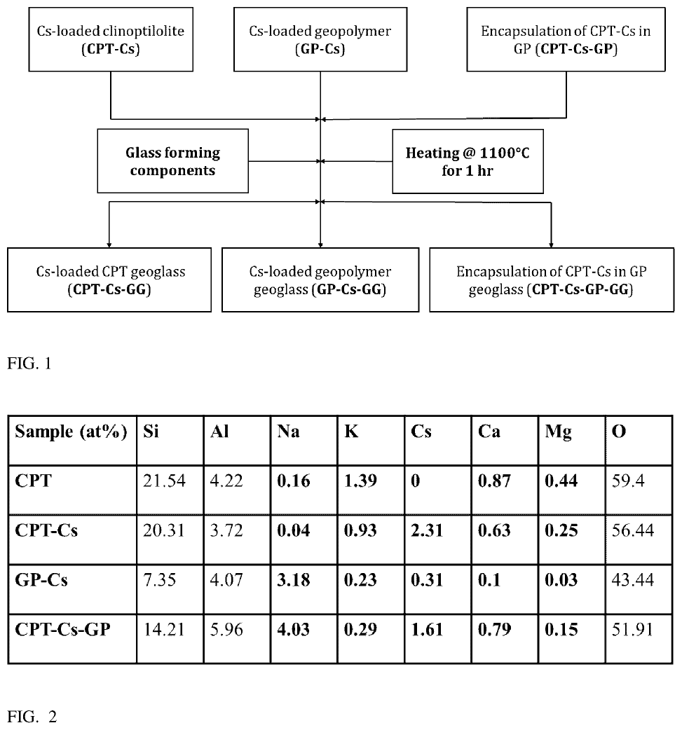

Referring to the drawings, FIG. 1 is a flow chart showing the experiment approach followed in the creation of the Geoglass materials.

FIG. 2 is a table showing the compositions of the wasteforms. As can be seen, the original CPT has no measurable cesium, whereas the Cs-loaded CPT has a lot of cesium. That is, this table demonstrates that the exchange of Cs⁺ replacing Na⁺ and K⁺ has been observed from EPMA.

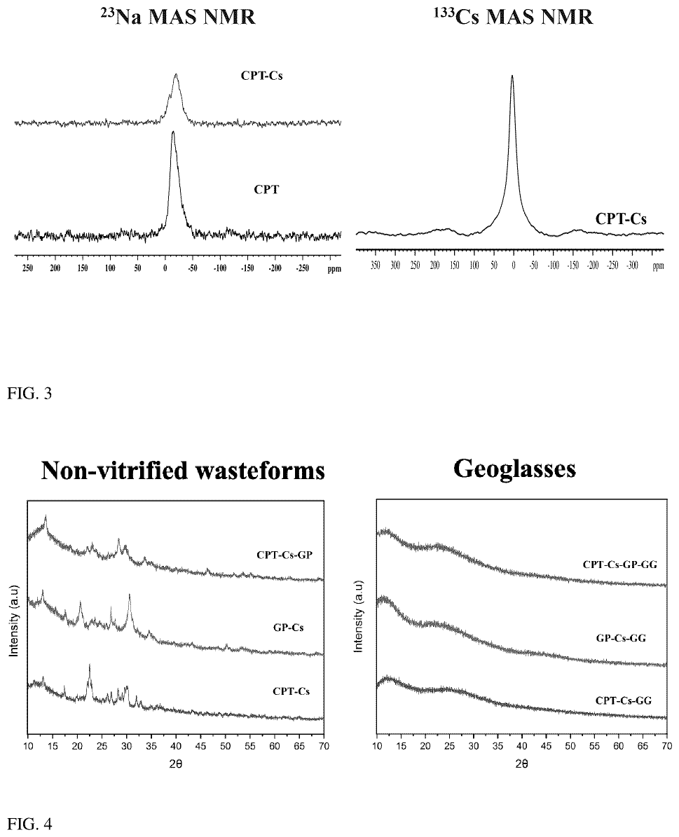

In FIG. 3, the ²³Na graphs show that some of the sodium has been replaced in the zeolite structure whereas the ¹³³Cs graph shows that cesium is present in a crystalline (i.e., not glassy) environment.

FIG. 4 shows the differences in homogeneity between the non-vitrified wasteforms and the Geoglasses of the invention.

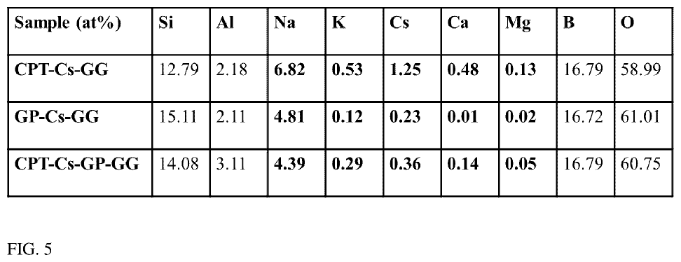

FIG. 5 demonstrates that all three Geoglasses contain cesium from the original wasteforms. Specifically, the Geoglass made from geopolymer has the least (because GP doesn't take up Cs very well) and the Geoglass made from zeolite has the most.

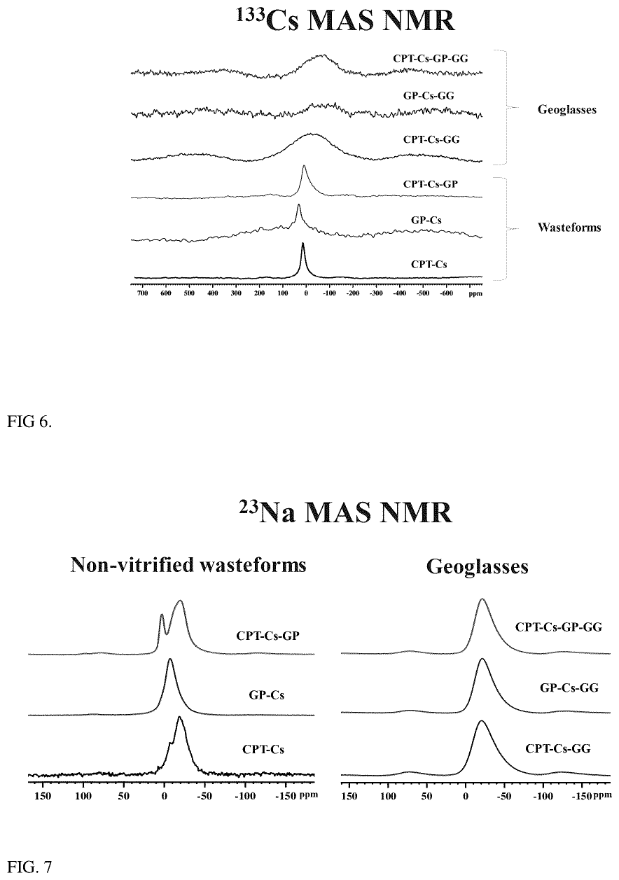

Referring to FIG. 6, sharp peaks indicate ordered crystalline cesium environments for the non-vitrified wasteforms, while broad peaks indicate glassy disorder around cesium for all Geoglasses.

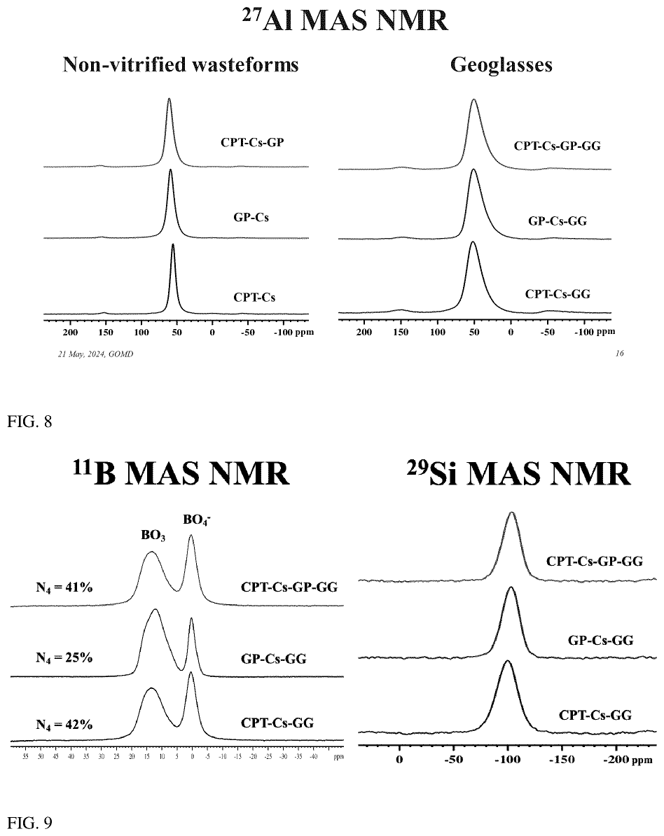

As such, FIGS. 6-8 all show the difference in homogeneity between the non-vitrified wasteforms and the Geoglass.

FIG. 9 also shows that significant differences in ratios of boron units are observed. Specifically, the boron-11 NMR spectra show that the relative amounts (change in relative peak intensities) of four-coordinate [BO₄⁻] and three-coordinate boron [BO₃] are different in the three different geoglasses. The number of boron-oxygen bonds influences the “connectivity” of the glass; higher connectivity generally produces higher chemical durability which means lower Cs release-hence, better materials for long-term cesium retention.

Furthermore, static dissolution trials based on a modified MCC-1 procedure were conducted on the cesium-loaded Geoglasses and non-vitrified wasteforms.

Aliquots of the leachate were collected after 5 hours, 10 hours, 1 day, 8 days, 12 days, and 24 days respectively and analyzed using ICP-MS.

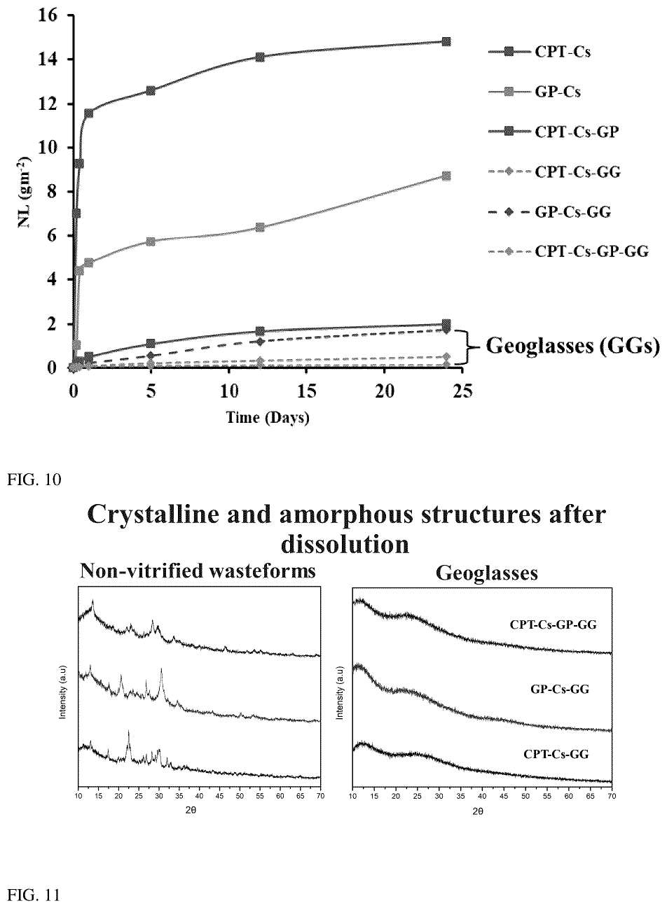

FIG. 10 shows the release of cesium into solution over time. As can be seen, very little cesium is released by the Geoglasses, especially compared to the non-vitrified wasteforms.

As shown in FIG. 11, after 24 days of dissolution, Geoglasses retained their amorphous character with improved chemical durability. Specifically, this demonstrates that Geoglasses remain amorphous after extended exposure to water. Some amorphous wasteforms (e.g., those used for high-level waste) form crystalline precipitates after dissolution, which diminishes the effectiveness of the materials for long-term nuclear waste immobilization. However, the Geoglasses do not appear to do so under the conditions tested, which are standard for the industry.

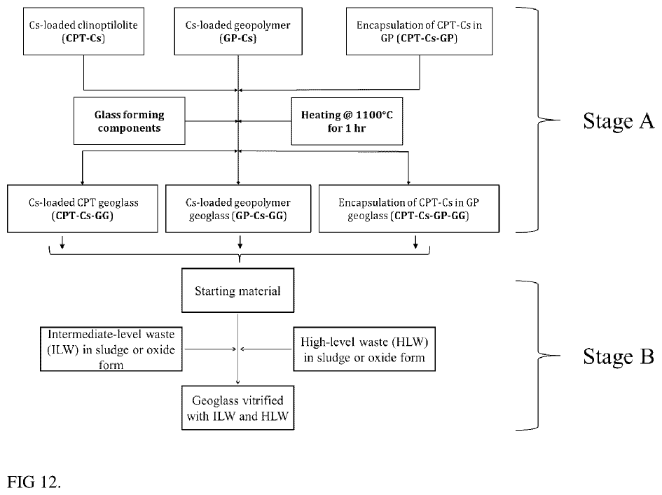

A scheme where waste-loaded Geoglasses (stage A) are further used to vitrify intermediate-level and high-level wastes originating from nuclear reactor sites and fuel-reprocessing facilities (stage B) is presented in FIG. 12.

In summary, as can be seen from the data provided above, the vitrification process with B₂O₃ significantly improves the chemical durability of wasteforms.

Furthermore, Geoglass exhibits high ion-retention capability compared to their non-vitrified wasteforms.

As such, Geoglass offers an effective storage solution for the incorporation of Cs from contaminated wastewater.

While the preferred embodiments of the invention have been described above, it will be recognized and understood that various modifications may be made therein, and the appended claims are intended to cover all such modifications which may fall within the spirit and scope of the invention.

1. A method for preparing a waste-loaded vitrified zeolite composition comprising:
providing waste-loaded variants comprising waste-loaded CPT in dehydrated or non-dehydrated forms, either as CPT alone (CPT-Cs) or waste-loaded CPT as a geopolymer (CPT-Cs-GP), and at different stages of maturation;
adding suitable glass-forming chemicals to the waste-loaded variants, thereby forming a mixture;
grinding the mixture;
forming a melt from the mixture by heating; and
allowing the melt to cool, thereby forming a waste-loaded zeolite glass composition (CPT-Cs-GG and CPT-Cs-GP-GG).

2. The method according to claim 1, wherein the waste-loaded zeolite is cesium-loaded zeolite, for example, CPT.

3. The method according to claim 1, wherein the waste-loaded zeolite is dehydrated at about 50-300° C.

4. The method according to claim 1, wherein the suitable glass-forming chemicals are added in appropriate amounts to achieve the target final glass composition.

5. The method according to claim 1, wherein the suitable glass-forming chemicals include or comprise about 15 parts (Na₂O), about 5 parts (Al₂O₃), about 25 parts (B₂O₃) and about 55 (SiO₂).

6. The method according to claim 1 wherein the suitable glass forming chemicals include or comprise about 5-30 parts (Na₂O), about 5-30 parts (Al₂O₃), about 15-40 parts (B₂O₃) and about 40-60 (SiO₂) or 5-30 (Na₂O)-5-30 (Al₂O₃)-15-40 (B₂O₃)-40-60 (SiO₂).

7. The method according to claim 1 wherein the suitable glass-forming chemicals include or comprise about 5-30 parts (Na₂O), about 5-30 parts (Al₂O₃), about 15-40 parts (B₂O₃), about 1-10 parts of (P₂O₅) and about 40-60 (SiO₂) or 5-30 (Na₂O)-5-30 (Al₂O₃)-15-40 (B₂O₃)-40-60 (SiO₂)-1-10 (P₂O₅).

8. The method according to claim 1 wherein the waste-loaded zeolite glass is used as a starting material for the vitrification of intermediate- and high-level waste.
